(19) United States
(12) Patent Application Publication
(10) Pub. No.: US 2003/0181582 A1
(43) Pub. Date: Sep. 25, 2003

(54) Weather-resistant polymer blends

(76) Inventors: Holger Warth, Dormagen (DE); Gerwolf Quaas, K?ouml;ln (DE); Dieter Wittmann, Leverkusen (DE); Heinrich Alberts, Odenthal (DE)

Correspondence Address: BAYER POLYMERS LLC, 100 BAYER ROAD, PITTSBURGH, PA, 15205, US

(21) Appl. No.: 10/276,527

(22) PCT Filed: May 7, 2001
(86) PCT No.: PCT/EP01/05141

(30) Foreign Application Priority Data
May 19, 2000 (DE) 100 24 933.7
May 19, 2000 (DE) 100 24 935.3
Feb. 26, 2001 (DE) 100 09 225.3

(51) Int. Cl. C08L 51/00

(52) U.S. Cl. 525/66

(57) ABSTRACT

The present invention relates to weather-resistant polymer blends containing

A) polyamide,

B) at least one rubber-elastic graft polymer selected from the group consisting of silicone rubber, EP(D)M rubber and acrylate rubber as graft base,

C) at least one compatibilizer containing at least one thermoplastic polymer having polar groups and,

D) optionally, at least one vinyl (co)polymer.

The present invention relates to polymer blends based on polyamide and graft polymers selected from the group consisting of the silicone rubbers, EP(D)M rubbers and acrylate rubbers as graft base that have very good mechanical properties, such as tensile strength and weather resistance.

EP-A-202 214 describes polyamide/ABS blends that additionally contain compatibilizers having functional groups that can react with the amine or acid terminal groups of the polyamides.

DE-A-39 38 421 describes thermoplastic polyamide moulding compositions using graft polymers that are produced after a certain redox polymerisation process and contain tertiary butyl acrylates in the envelope.

Finally, EP-A-785 234 describes polymer compositions that contain graft polymers of aromatic vinyl monomers and monomers composed of alkyl (meth)acrylates or acrylonitrile on a rubber as first component, a thermoplastic polymer containing polar groups as second component and a compatibilizer as third component.

The object of the present invention is to provide polymer blends having excellent mechanical properties, such as tensile strength and weather resistance.

It has now been found that polymer blends based on polyamide and graft polymers selected from the group consisting of the silicone rubbers, EP(D)M rubbers and acrylate rubbers that contain compatibilizers have the desired properties.

The present invention therefore provides polymer blends containing

A) polyamide,

B) at least one rubber-elastic graft polymer selected from the group consisting of silicone rubber, EP(D)M rubber and acrylate rubber as graft base,

C) at least one compatibilizer containing at least one thermoplastic polymer having polar groups and,

D) optionally, at least one vinyl (co)polymer.

The present invention preferably provides polymer blends containing

10 to 98, preferably 15 to 70, particularly preferably 20 to 60 parts by weight of polyamide A,

0.5 to 80, preferably 10 to 70, particularly preferably 20 to 65 parts by weight of a mixture composed of the components B and optionally D, or

0.5 to 50, preferably 1 to 30, particularly preferably 2 to 10 parts by weight of a compatibilizer containing at least one thermoplastic polymer having polar groups.

Component A

Suitable polyamides according to the invention are known homopolyamides, copolyamides and mixtures of said polyamides. These may be partially crystalline and/or amorphous polyamides. Suitable as partially crystalline polyamides are nylon-6, nylon-6,6, mixtures and corresponding copolymers of said components. Furthermore, those partially crystalline polyamides are suitable whose acid component is composed completely or partially of terephthalic acid and/or isophthalic acid and/or suberic acid and/or sebacic acid and/or azelaic acid and/or adipic acid and/or cyclohexanedicarboxylic acid and whose diamine component is composed entirely or partially of m- and/or p-xylylenediamine and/or hexamethylenediamine and/or 2,2,4-trimethylhexamethylenediamine and/or 2,4,4-trimethylhexamethylenediamine and/or isophoronediamine and whose composition is known in principle.

In addition, polyamides may be mentioned that are prepared entirely or partially from lactams containing 7 to 12 carbon atoms in the ring, optionally with the concomitant use of one or more of the abovementioned starting components.

Particularly preferred partially crystalline polyamides are nylon-6 and nylon-6,6 and their mixtures. Known products may be used as amorphous polyamides. They are obtained by polycondensation of diamines, such as ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminocyclohexyl)propane, 3,3′-dimethyl-4,4′-diaminodicyclohexylmethane, 3-aminomethyl-3,5,5-trimethylcyclohexylamine, 2,5- and/or 2,6-bis(aminomethyl)norbornane and/or 1,4-diaminomethylcyclohexane with dicarboxylic acids, such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Copolymers that are obtained by polycondensation of a plurality of monomers are also suitable, as are copolymers that are prepared by adding amino acids, such as ε-aminocaproic acid, ω-aminoundecanoic acid or ω-aminolauric acid or their lactams.

Particularly suitable amorphous polyamides are the polyamides prepared from isophthalic acid, hexamethylenediamine and further diamines, such as 4,4-diaminodicyclohexylmethane, isophoronediamine, 2,2,4- and/or 2,4,4-trimethylhexamethylenediamine, 2,5- and/or 2,6-bis(aminomethyl)norbornene; or from isophthalic acid, 4,4′-diaminodicyclohexylnethane and ε-caprolactam; or from isophthalic acid, 3,3′-dimethyl-4,4′-diamino-dicyclohexylmethane and laurolactam; or from terephthalic acid and the isomeric mixture of 2,2,4- and/or 2,4,4-trimethylhexamethylenediamine.

Instead of the pure 4,4′-diaminodicyclohexylmethane, mixtures of the positional isomers diaminodicyclohexylmethane may also be used that are composed of

| | |
|---|---|
| 70 to 99 mol % | of the 4,4′-diamino isomers, |
| 1 to 30 mol % | of the 2,4′-diamino isomers, |
| 0 to 2 mol % | of the 2,2′-diamino isomers, |

optionally correspondingly higher condensed diamines that are obtained by hydrogenation of diaminodiphenylmethane of technical quality. Up to 30% of the isophthalic acid may be replaced by terephthalic acid.

The polyamides preferably have a relative viscosity (measured on a 1 wt. % solution of m-cresol at 25° C.) of 2.0 to 5.0, particularly preferably of 2.5 to 4.0.

Component B

Component B comprises one or more rubber-elastic graft polymers selected from the group consisting of silicone rubbers, acrylate rubbers and EP(D)M rubbers as graft base.

Preferably, component B comprises one or more graft polymers of

B.1 5 to 95, preferably 20 to 80, in particular 30 to 80 wt. %, of at least one vinyl monomer on

B.2 95 to 5, preferably 80 to 20, in particular 70 to 20 wt. % of one or more graft bases having glass transition temperatures of <10° C., preferably of <0° C., particularly preferably of <−20° C., selected from the group consisting of silicone rubbers, acrylate rubbers and EP(D)M rubbers.

The graft base B.2 generally has a mean particle size (d₅₀ value) of 0.05 to 5 μm, preferably 0.10 to 0.5 μm, particularly preferably 0.20 to 0.40 μm.

Vinyl monomers that can be used according to the invention in accordance with component B.1 are those composed of at least one monomer from the series: vinylaromatics and/or ring-substituted vinylaromatics (such as, for example, styrene, α-methylstyrene, p-methylstyrene, p-chlorostyrene), (C₁-C₈)-alkyl methacrylates (such as, for example, methyl methacrylate, ethyl methacrylate) (B.1.1) with at least one monomer from the series: vinyl cyanides (unsaturated nitriles, such as acrylonitrile and methacrylonitrile), (C₁-C₈)-alkyl (meth)acrylates (such as, for example, methyl methacrylate, n-butyl acrylate, tert-butyl acrylate), derivatives (such as anhydrides and imides) of unsaturated carboxylic acids (for example maleic anhydride and N-phenylmaleinimide). (B.1.2).

Preferably component B.1 is a mixture of

50 to 99, preferably 60 to 80 parts by weight of component B.1.1 and

1 to 50, preferably 40 to 20 parts by weight of component B.1.2.

(C₁-C₈)-alkyl acrylates or (C₁-C₈)-alkyl methacrylates are esters of acrylic acid or of methacrylic acid and monohydric alcohols containing 1 to 8 carbon atoms. Particularly preferred is methyl methacrylate, ethyl methacrylate and propyl methacrylate. Methyl methacrylate is mentioned as particularly preferred methacrylate.

Thermoplastic (co)polymers having a composition in accordance with component D may be produced as a by-product in the graft polymerization for preparing the component B, particularly if large amounts of monomers are grafted onto small amounts of rubber.

For the purpose of the present invention, graft polymer B) is understood as meaning the product, produced during the graft polymerization, from grafted rubber and the (co)polymer produced during the graft polymerization. The amounts of the (co)polymer produced spontaneously during the graft polymerization depend, inter alia, on the monomer composition and the method of polymerization.

Since, according to the amount and, optionally, the nature of the separately added (co)polymer D), the latter cannot be distinguished from the (co)polymer produced during the polymerization of the graft polymer, the sum of the amounts of components B) and D) is equivalent to the sum of graft polymer and (co)polymer.

Particularly preferred vinyl monomers B.1 are styrene and acrylonitrile and, optionally, methyl methacrylate, α-methylstyrene and acrylonitrile and, optionally, methyl methacrylate, or styrene, α-methylstyrene and acrylonitrile and, optionally, methyl methacrylate.

Silicone rubbers B.2 that are suitable according to the invention are composed predominantly of the structural units

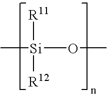

where

R¹¹ and R¹² may be identical or different and denote (C₁-C₆)-alkyl or cycloalkyl or (C₆-C₂)-aryl and n denotes an integer.

Preferred silicone rubbers B.2 are particulate and have a mean particle diameter d₅₀ of 0.09 to 1 μm, preferably 0.09 to 0.4 μm and a gel content of more than 70 wt. %, in particular 73 to 98 wt. % and are obtainable from

1) dihaloorganosilanes,

2) 0 to 10 mol %, relative to 1), of trihalosilanes and

3) 0 to 3 mol %, relative to 1), of tetrahalosilanes and

4) 0 to 0.5 mol %, relative to 1) of halotriorganosilanes, wherein the organic radicals in compounds 1), 2), and 4) are

α) (C₁-C₆)-alkyl or cyclohexyl, preferably methyl or ethyl,

β) (C₆-C₂)-aryl, preferably phenyl,

γ) (C₁-C₆)-alkenyl, preferably vinyl or allyl and

δ) mercapto (C₁-C₆)-alkyl, preferably mercaptopropyl, with the proviso that the sum (γ+δ) is 2 to 10 mol %, relative to all the organic radicals of compounds 1), 2) and 4) and the molar ratio γ:δ=3:1 to 1:3, preferably 2:1 to 1:2.

Preferred silicone rubbers B.2 contain, as organic radicals, at least 80 mol % of methyl groups. The terminal group is generally a diorganyl-hydroxyl-siloxy unit, preferably a dimethylhydroxysiloxy unit.

Preferred silanes 1) to 4) for the preparation of silicone rubbers B.2 contain chlorine as halogen substitute.

“Obtainable” means that the silicone rubber B.2 does not necessarily have to be produced from the halogen compounds 1) to 4). Silicone rubbers B.2 of identical structure that are prepared from silanes containing other hydrolysable groups, such as, for example (C₁-C₆)-alkoxy groups or from cyclic siloxane oligomers are also to be included.

Silicone graft rubbers are mentioned as particularly preferred component B.2. These can be prepared, for example, by a three-stage process.

In the first stage, monomers, such as dimethyldichlorosilane, vinylmethyldichlorosilane or dichlorosilanes having other substituents are reacted (cf. Chemie in unserer Zeit 4 (1987), 121-127) to form the cyclic oligomers (octamethylcyclotetrasiloxane or tetravinyltetramethylcyclotetrasiloxane) that can easily be purified by distillation.

In the second stage, the crosslinked silicone rubbers are obtained by ring-opening cationic polymerization from said cyclic oligomers with the addition of mercaptopropylmethyldimethoxysilane.

In the third stage, the silicone rubbers obtained, which have vinyl and mercapto groups with grafting activity, are free-radical graft-polymerized with vinylmonomers (or mixtures).

Preferably, in the second stage, mixtures of cyclic siloxane oligomers, such as octamethylcyclotetrasiloxane and tetramethyltetravinylcyclotetrasiloxane are cationically polymerized by ring opening in emulsion. The silicone rubbers are produced in particulate form as an emulsion.

Particularly preferably, alkylbenzenesulfonic acids, which are active both catalytically and as emulsifiers, are employed in accordance with GB-A 1 024 014. The acid is neutralized after the polymerization. Instead of alkylbenzenesulfonic acids, n-alkylsulfonic acids can also be used. It is also possible to use co-emulsifiers additionally to the sulfonic acid.

Co-emulsifiers may be nonionic or anionic. Suitable as anionic co-emulsifiers are, in particular, salts of n-alkyl- or alkylbenzenesulfonic acids. Nonionic co-emulsifiers are polyoxyethylene derivatives of fatty alcohols and fatty acids. Examples are POE (3)-lauryl alcohol, POE (20)-oleyl alcohol, POE (7)-nonyl alcohol or POE (10)-stearate. (The notation POE (number) . . . alcohol means that as many units of ethylene oxide as correspond to the number are added to one molecule of the . . . alcohol. POE stands for poly(ethylene oxide). The number is an average.)

The groups having crosslinking and grafting activity (vinyl and mercapto groups, cf. organic radicals γ and δ) can be inserted into the silicone rubber by using suitable siloxane oligomers. These are, for example, tetramethyltetravinylcyclotetrasiloxane or γ-mercaptopropylmethyldimethoxysiloxane or their hydrolysates.

They are added to the main oligomer, for example octamethylcyclotetrasiloxane, in the desired amounts in the second stage.

The incorporation of longer-chain alkyl radicals, such as, for example, ethyl, propyl or the like or the incorporation of phenyl groups can also be achieved analogously.

An adequate crosslinking of the silicone rubber can even be achieved if the radicals γ and δ react with one another during the emulsion polymerization so that the addition of an external crosslinking agent may be unnecessary. However, a crosslinking silane may be added in the second reaction stage in order to increase the degree of crosslinking of the silicone rubber.

Branching and crosslinking can be achieved by adding, for example, tetraethoxysilane or a silane of the formula

y−SiX₃,

where X is a hydrolysable group, in particular an alkoxy or halogen radical, and y is an organic radical.

Preferred silanes y−SiX₃ are methyltrimethoxysilane and phenyltrimethoxysilane.

The gel content is determined in acetone at 25° C. (cf. DE-AS 2 521 288, column 6, lines 17 to 37). In the silicone rubbers according to the invention, it is at least 70 wt. %, preferably 73 to 98 wt. %.

Grafted silicone rubbers B can be prepared by free-radical graft polymerization, for example analogously to DE-PS 2 421 288.

To prepare the grafted silicone rubber in the third stage, the graft monomers can be free-radical graft-polymerized in the presence of silicone rubber, in particular at 40 to 90° C. The graft polymerization can be performed in suspension, dispersion or emulsion. Preferred is the continuous or batch emulsion polymerization. Said graft polymerization is performed with free-radical initiators (for example, peroxides, azo compounds, hydroperoxides, persulfates, perphosphates) and, optionally, using anionic emulsifiers, for example carboxonium salts, sulfonic acid salts or organic sulfates. In this connection, graft polymers are formed with high graft yields, i.e. a large proportion of the polymer of the graft monomers is chemically bound to the silicone rubber. The silicone rubber has radicals with grafting activity so that special measures for strong grafting are superfluous.

The grafted silicone rubbers can be prepared by graft polymerization of 5 to 95 parts by weight, preferably 20 to 80 parts by weight, of a vinyl monomer or of a vinyl monomer mixture onto 5 to 95, preferably 20 to 80 parts by weight, of silicone rubber.

A particularly preferred vinyl monomer is styrene or methyl methacrylate. Suitable vinyl monomer mixtures are composed of 50 to 95 parts by weight of styrene, α-methyl styrene (or other alkyl or halogen-nuclear-substituted styrenes) or methyl methacrylate, on the one hand, and of 5 to 50 parts by weight of acrylonitrile, methacrylonitrile, (C₁C₁₈)-alkyl acrylates, (C₁-C₁₆)-alkyl methacrylates, maleic anhydride or substituted maleic imides, on the other hand. As further vinyl monomers, acrylic acid esters of primary or secondary aliphatic (C₂-C₁₀)-alcohols, preferably n-butyl acrylate or tert-butanol acrylate or methacrylate, preferably tert-butyl acrylate may additionally be present in smaller amounts. A particularly preferred monomer mixture is 30 to 40 parts by weight of α-methyl styrene, 52 to 62 parts by weight of methyl methacrylate and 4 to 14 parts by weight of acrylonitrile.

The silicone rubbers grafted in this way can be worked-up in a known manner, for example by coagulation of the lattices with electrolytes (salts, acids or mixtures thereof) and then purification and drying.

During the preparation of the grafted silicone rubbers, there are generally formed, in addition to the actual graft copolymer, also to a certain extent free polymers or copolymers of the graft monomers forming the graft envelope. Here, grafted silicone rubber denotes the product obtained by the polymerization of the graft monomers in the presence of the silicone rubber, strictly speaking, therefore, generally a mixture of graft copolymer and free (co)copolymer of the graft monomers.

Acrylate-based graft polymers are preferably composed of

a) 20 to 90 wt. %, relative to the graft polymer, of acrylate rubber having a glass transition temperature below −20° C. as graft base and

b) 10 to 80 wt. %, relative to the graft polymer, of at least one polymerizable, ethylenically unsatured monomer (cf. B.1) as graft monomer.

The acrylate rubbers (a) are preferably polymers of alkyl acrylates, optionally with up to 40 wt. %, relative to (a), of other polymerizable, ethylenically unsaturated monomers. The preferred polymerizable acrylates include (C₁C₈)-alkyl esters, for example methyl, ethyl, butyl, n-octyl and 2-ethylhexyl esters; haloalkyl esters, preferably halo (C₁-C₈)-alkyl esters, such as chloroethyl acrylate, and also mixtures of said monomers.

For the purpose of crosslinking, monomers can be copolymerized with more than one polymerizable double bond. Preferred examples of crosslinking monomers are esters of unsaturated monocarboxylic acids containing 3 to 8 carbon atoms and unsaturated monohydric alcohols containing 3 to 12 carbon atoms, or saturated polyols containing 2 to 4 OH groups and 2 to 20 carbon atoms, such as, for example, ethylene glycol dimethacrylate, allyl methacrylate; polyunsaturated heterocyclic compounds, such as, for example, trivinyl and triallyl cyanurate; polyfunctional vinyl compounds, such as di- and trivinyl benzenes; and also triallyl phosphate and diallyl phthalate.

Preferred crosslinking monomers are allyl methacrylate, ethylene glycol dimethacrylate, diallyl phthalate and heterocyclic compounds that contain at least three ethylenically unsaturated groups.

Particularly preferred crosslinking monomers are the cyclic monomers triallyl cyanurate, triallyl isocyanurate, triacryloylhexahydro-s-triazine, triallyl benzenes.

The amount of the crosslinking monomers is preferably 0.02 to 5, in particular 0.05 to 2, wt. %, relative to the rubber base.

In the case of cyclic crosslinking monomers containing at least three ethylenically unsaturated groups, it is advantageous to limit the amount to below 1 wt. % of the rubber base.

Preferred “other” polymerizable, ethylenically unsaturated monomers that may serve, in addition to the acrylates, optionally for the preparation of the graft base B.2, are, for example, acrylonitrile, styrene, α-methyl styrene, acrylamides, vinyl (C₁-C₆)-alkyl ethers, methyl methacrylate, butadiene. Preferred acrylate rubbers as graft base B.2 are emulsion polymers that have a gel content of at least 60 wt. %.

The acrylate-based polymers are generally known and can be prepared by known methods (for example, EP-A 244 857), or are commercial products.

The gel content of the graft base is determined at 25° C. in a suitable solvent (M. Hoffmann, H. Kromer, R. Kuhn, Polymeranalytik I und II, Georg Thieme-Verlag, Stuttgart 1977).

The mean particle size d₅₀ is the diameter above and below which 50 wt. % of the particles lie in each case. It can be determined by means of ultracentrifuge measurement (W. Scholtan, H. Lange, Kolloid-Z. und Z. Polymere, 250 (1972), 782-796).

At least one ethylene- and propylene-containing copolymer or terpolymer having only a small number of double bonds is used as EP(D)M graft base (cf. EP-A 163 411, EP-A 244 857).

Used as EP(D)M rubbers are those that have a glass transition temperature in the range from −60 to −40° C. The rubbers have only a small number of double bonds, i.e. less than 20 double bonds per 1000 carbon atoms, in particular 3 to 10 double bonds per 1000 carbon atoms. Examples of such rubbers are copolymers composed of ethylene-propylene, and also ethylene-propylene terpolymers. The latter are prepared by polymerization of at least 30 wt. % of ethylene, at least 30 wt. % of propylene and 0.5 to 15 wt. % of an unconjugated diolefinic component. Used as tercomponents are, as a rule, diolefins containing at least 5 carbon atoms, such as 5-ethylidenenorbornene, dicyclopentadiene, 2,2,1-dicyclopentadiene and 1,4-hexadiene. Suitable, are furthermore, polyalkyleneamers, such as polypenteneamer, polyocteneamer, polydodecaneamer or mixtures of said substances. Furthermore, those partially hydrogenated polybutadiene rubbers are also suitable in which at least 70% of the residual double bonds arc hydrogenated. Of the abovementioned rubbers, in particular, the ethylene-propylene copolymers and the ethylene-propylene terpolymers (EPDM rubbers) are used. As a rule, EPDM rubbers have a Mooney viscosity ML₁₋₄(100° C.) of 25 to 120. They are commercially available.

The graft polymers based on EP(D)M can be prepared by various methods. Preferably, a solution of the EP(D)M elastomer (rubber) in the monomer mixture and (optionally) inert solvents is prepared and the graft reaction is performed by free-radical starters, such as azo compounds or peroxides, at fairly high temperatures. By way of example, the methods of DE-AS 23 02 014 and DE-A 25 33 991 may be mentioned. It is also possible to work in suspension, as described in U.S. Pat. No. 4,202,948.

Component C

According to the invention, thermoplastic polymers having polar groups are preferably used as compatibilizers.

According to the invention, polymers are preferably used that contain

C. 1 a vinyl-aromatic monomer,

C.2 at least one monomer selected from the group consisting of C₂- to C₁₂-alkyl methacrylates, C₂- to C₁₂-alkyl acrylates, methacrylonitriles and acrylonitriles, and

C.3 dicarboxylic anhydrides containing α-, β-unsaturated components.

Styrene is particularly preferred as vinyl-aromatic monomer C.1.

Acrylonitrile is particularly preferred as component C.2.

Particularly preferred for dicarboxylic anhydrides C.3 containing α-, β-unsaturated components is maleic anhydride.

Preferably, terpolymers of the said monomers are used as component C.1, C.2 and C.3. Accordingly, terpolymers of styrene, acrylonitrile and maleic anhydride are preferably used. Said terpolymers contribute, in particular, to the improvement of the mechanical properties, such as tensile strength and weather resistance. The amount of maleic anhydride in the terpolymer may vary within wide limits. Preferably, the amount is 0.2-5 mol %. Particularly preferably, amounts of between 0.5 and 1.5 mol % are contained in the component C.1. In this range, particularly good mechanical properties are achieved in relation to tensile strength and weathering resistance.

The terpolymer can be prepared in a manner known per se. A suitable method is the dissolution of monomer components of the terpolymer, for example of styrene, maleic anhydride or acrylonitrile, in a suitable solvent, for example methyl ethyl ketone (MEK). One or, optionally, more chemical initiators are added to this solution. Suitable initiators are, for example, peroxides. The mixture is then polymerized at elevated temperature for several hours. The solvent and the unreacted monomers are then removed in a manner known per se.

The ratio between the component C.1 (vinyl-aromatic monomer) and the component C.2, for example, the acrylonitrile monomer, in the terpolymer is preferably between 80:20 and 50:50. In order to improve the miscibility of the terpolymer with the graft copolymer B, an amount of vinyl-aromatic monomer C.1 is preferably chosen that corresponds to the amount of the vinyl monomer B.1 in the graft copolymer B.

The amount of component C in the polymer blend according to the invention is between 0.5 and 50 wt. %, preferably between 1 and 30 wt. %, particularly preferably between 2 and 10 wt. %. Highly preferable are amounts between 5 and 7 wt. %.

Such polymers are described, for example, in EP-A-785 234 and EP-A-202 214. According to the invention, the polymers mentioned in EP-A-202 214, in particular, are preferred.

Component D

Component D comprises one or more thermoplastic vinyl (co)polymers.

Suitable as vinyl (co)polymers D are polymers of at least one monomer from the group consisting of the vinyl aromatics, vinyl cyanides (unsaturated nitriles), (C₁-C₈)-alkyl (meth)acrylates, unsaturated carboxylic acids and derivatives (such as anhydrides and imides) of unsaturated carboxylic acids. Suitable, in particular are (co)polymers of

D.1 50 to 99, preferably 60 to 80 parts by weight of vinyl aromatics and/or ring-substituted vinyl aromatics, such as, for example, styrene, α-methyl styrene, p-methyl styrene, p-chlorostyrene and/or (C₁-C₈)-alkyl methacrylates, such as, for example, methyl methacrylate, ethyl methacrylate, and

D.2 1 to 50, preferably 20 to 40 parts by weight of vinyl cyanides (unsaturated nitriles), such as acrylonitrile and methacrylonitrile, and/or (C₁-C₈)-alkyl (meth)acrylates (such as, for example, methyl methacrylate, n-butyl acrylate, tert-butyl acrylate) and/or unsaturated carboxylic acids (such as maleic acid) and/or derivatives (such as anhydrides and imides) of unsaturated carboxylic acids (for example, maleic anhydride and N-phenyl maleinimide).

The (co)polymers D are resinous, thermoplastic and rubber-free.

Particularly preferred is the copolymer of D.1 styrene and D.2 acrylonitrile.

The (co)polymers according to D are known and can be prepared by free-radical polymerization, in particular by emulsion, suspension, solution or bulk polymerization. The (co)polymers preferably have molecular weights \overline{M}_{w} (weight average, determined by light scattering or sedimentation) of between 15,000 and 200,000.

(Co)polymers according to component D are frequently produced as by-products in the graft polymerization of component B, particularly if large amounts of monomers B.1 are grafted onto small amounts of rubber B.2.

Component E

The polymer blends according to the invention may contain conventional additives such as flame retardants, anti-dripping agents, finely divided inorganic compounds, lubricants and mould release agents, nucleation agents, antistatics, stabilizers, fillers and reinforcing substances, and also dyes and pigments.

The polymer blends according to the invention may contain, in general, 0.01 to 20 wt. %, relative to the total moulding composition, of flame retardant. By way of example, organic halogen compounds, such as decabromobisphenyl ether, tetrabromobisphenol, inorganic halogen compounds, such as ammonium bromide, nitrogen compounds, such as melamine, melamine-formaldehyde resins, inorganic hydroxide compounds, such as Mg-Al hydroxide, inorganic compounds, such as aluminium oxides, titanium dioxides, antimony oxides, barium metaborate, hydroxoantimonate, zirconium oxide, zirconium hydroxide, molybdenum oxide, ammonium molybdate, tin borate, ammonium borate and tin oxide, and also siloxane compounds may be mentioned as flame retardant.

Furthermore, phosphorous compounds, such as those described in EP-A-363 608, EP-A-345 522 or EP-A-640 655 may be used as flame-retardant compounds.

The usable inorganic compounds comprise compounds of one or more metals of main groups 1 to 5 and of the subgroups 1 to 8 of the period system, preferably of the main groups 2 to 5 and of the subgroups 4 to 8, particularly preferably of the main groups 3 to 5 and of the subgroups 4 to 8, with the elements oxygen, sulfur, boron, phosphorous, carbon, nitrogen, hydrogen and/or silicone.

Examples of such compounds are oxides, hydroxides, hydrous oxides, sulfates, sulfites, sulfides, carbonates, carbides, nitrates, nitrites, nitrides, borates, silicates, phosphates, hydrides, phosphites or phosphonates. These include, for example, TiN, TiO₂, SnO₂, WC, ZnO, Al₂O₃, AlO(OH), ZrO₂, Sb₂O₃, SiO₂, iron oxide, NaSO₄, BaSO₄, vanadium oxides, zinc borate, silicates, such as Al silicates, Mg silicates, one-, two- and three-dimensional silicates, and mixtures and doped compounds can likewise be used. Furthermore, these nano-scale particles are surface-modified with organic molecules in order to achieve better compatibility with the polymers. In this way, hydrophobic or hydrophilic surfaces can be produced.

The average particle diameters are less than or equal to 200 nm, preferably less than or equal to 150 nm, in particular 1 to 100 nm.

Particle size and particle diameter always denotes the mean particle diameter d₅₀, determined by ultracentrifuge measurements according to W. Scholtan et al., Kolloid-Z. und Z. Polymere, 250 (1972), pages 782 to 796.

The inorganic compounds may be powders, pastes, sols, dispersions or suspensions. Powders may be obtained by precipitation from dispersions, sols or suspensions.

The powders can be incorporated in the thermoplastics by conventional methods, for example by direct compounding or extrusion of the components of the moulding composition and of the extremely finely divided inorganic powders. Preferred methods are the preparation of a master batch, for example in flame-retardant additives, other additives, monomers, solvents, in component A or the co-precipitation of dispersions of component B or C with dispersions, suspensions, pastes or sols of the extremely finely divided inorganic materials.

For example, glass fibres, optionally cut or ground, glass beads, glass spheres, platelet-type reinforcement material, such as kaolin, talc, mica, silicates, quartz, talcum, titanium dioxide, wollastonite, carbon fibres or their mixtures may be present as filling and reinforcing materials. Preferably, cut or ground glass fibres are used as reinforcing material. Preferred fillers, which may also be reinforcing, are glass spheres, mica, silicates, quartz, talcum, titanium dioxide and wollastonite.

The polymer blends of the present invention can be used to prepare mouldings of any kind. In particular, mouldings can be produced by injection moulding. Examples of producible mouldings are: housing parts of every kind, for example for domestic appliances, such as fruit presses, coffee machines and mixers, or for office machines, such as computers, printers and monitors, or cover plates for the building sector and parts for the motor vehicle sector.

Particularly suitable are polymer blends for producing mouldings that are subjected to particularly high requirements in relation to weather resistance, tensile strength and stress cracking resistance.

The present invention also relates to the use of the polymer blends for preparing mouldings and also the mouldings obtainable therefrom.

The invention is explained in more detail below by reference to some examples:

### EXAMPLES

1. Components used

A Polyamide (DURETHAN B30 supplied by Bayer A G, Leverkusen, Germany)

B1 Graft polymer of 40 parts by weight of a copolymer of styrene and acrylonitrile in a ratio of 73:27 to 60 parts by weight of particulately crosslinked polybutadiene rubber (mean particle diameter d₅₀=0.28 μm), prepared by emulsion polymerization

B2 Acrylonitrile-ethylene-styrene copolymer (AES) with an EPDM proportion of approximately 70 wt. %, for example Blendex WX270 supplied by General Electric

B3 Acrylate-styrene-acrylonitrile copolymer (ASA) with a rubber content of approximately 60 wt. %, for example Blendex WX160 supplied by General Electric

B4 Silicone acrylate rubber having a core-shell structure composed of an acrylate core and a silicon shell having a G′ modulus level at room temperature of approximately 110 MPA:

(1) Metablen S2001 (Metablen Company B. V. Vlissingen, The Netherlands);

(2) Metablen SKR200 (Metablen Company B. V., Vlissingen, The Netherlands).

C Compatibilizer: terpolymer of styrene and acrylonitrile (2.1:1 weight ratio) containing 1 mol % of maleic anhydride

D Styrene/acrylonitrile copolymer having a styrene/acrylonitrile ratio of 72:28 and an intrinsic viscosity of 0.75 dl/g (measured in dimethylformamide at 20° C.)

E Mineral fillers according to U.S. Pat. No. 5,714,537

(1) Tremin 939-300 EST (talcum)

(2) Burgess 2211 (Al silicate)

(3) Wicroll 40PA (wollastonite)

(4) Finntalc M30SL (Finntalc)

F Additives

2. Preparation of the polymer blend

The polymer blends according to the invention are prepared by blending the respective components in a known manner and melt-compounding or melt-extruding at temperatures of 200 to 300° C. in conventional aggregates, such as internal mixers, extruders and twin-screw extruders, the fluorinated polyolefins preferably being used in the form of the coagulated mixture already mentioned.

The individual constituents can be blended in a known manner either consecutively or simultaneously, and specifically, either at about 20° C. (room temperature) or at elevated temperature.

3. Weather-resistant rubbers (ASA, AES, silicone acrylates instead of ABS)

a) with ASA+AES

| | | Comparison | | |
|---|---|---|---|---|
| | | example acc. to | Example | Example |
| | | EP-A 202 214 | 1 | 2 |
| A | pts. by wt. | 44 | 44 | 44 |
| B1 | pts. by wt. | 17 | — | — |
| B2 | pts. by wt. | — | 27 | — |
| B3 | pts. by wt. | — | — | 30 |
| C | pts. by wt. | 6 | 6 | 6 |
| D | pts. by wt. | 33 | 23 | 26 |
| F | pts. by wt. | 1.5 | 1.5 | 1.5 |
| Vicat A | ° C. | 186 | 191 | 188 |
| HDT A | ° C. | 65 | 67 | 72 |
| Melt volume rate | cm³/10 min. | 4 | 6 | 14 |
| Weathering | (Xe-WOM | − | + | + |
| | 1000 h) | | | |
| Elastic modulus | MPa | 1850 | 2000 | 1980 |
| Elongation at | % | 90 | 100 | 130 |
| break | | | | |

b) with silicon acrylate

| | | Comparison | | |
|---|---|---|---|---|
| | | example acc. to | Example | Example |
| | | EP-A 202 214 | 3 | 4 |
| A | pts. by wt. | 44 | 44 | 44 |
| B1 | pts. by wt. | 33 | 33 | 33 |
| B4 | pts. by wt. | — | 17(1) | 17(2) |
| C | pts. by wt. | 6 | 6 | 6 |
| D | pts. by wt. | 17 | — | — |
| F | pts. by wt. | 1.5 | 1.5 | 1.5 |
| Vicat B | ° C. | 103 | 106 | 107 |
| Melt volume rate | cm³/10 min. | 4 | 4.9 | 6.7 |
| Elastic modulus | MPa | 1850 | 1840 | 1950 |
| Elongation at | % | 90 | 140 | 110 |
| break | | | | |

The Vicat A and B softening points are determined according to DIN 53 460 (ISO 306).

The heat distortion temperature A was determined at 1.8 MPa according to ISO 75. The melt volume rate was determined according to ISO 527. The weathering was determined according to SAE J 1885: Appliance Uerit: Xe WO 11 Spray cycle: 102=18 Light exposure time: 1000 h Irradiation energy: 1260 KJ/m² Irradiation: 144.9 MJ/m²

The modulus of elasticity was determined according to DIN 53 457/ISO 527. The elongation at break was determined according to ISO 527.

1. Polymer blends containing
A) polyamide,
B) at least one rubber-elastic graft polymer selected from the group consisting of silicone rubber, EP(D)M rubber and acrylate rubber as graft base,
C) at least one compatibilizer containing at least one thermoplastic polymer having polar groups and, optionally,
D) at least one vinyl (co)polymer.

2. Weather-resistant polymer blends according to claim 1, containing
10-98 parts by weight of polyamide A,
0.5-80 parts by weight of component B,
0.5-50 parts by weight of component C and, optionally,
0.5-80 parts by weight of vinyl (co)polymer D.

3. Weather-resistant polymer blends according to claim 1, containing
15-70 parts by weight of polyamide A,
10-70 parts by weight of a mixture of components B and, optionally, D and
1-30 parts by weight of component C.

4. Polymer blends according to claim 1, containing
20-60 parts by weight of polyamide A,
20-65 parts by weight of a mixture of components B and, optionally, D and
2-10 parts by weight of component C.

5. Polymer blends according to claims 1 to 4, wherein component B) comprises one or more graft polymers of
B.1 5 to 95 wt. % of at least one vinyl monomer on
B.2 95 to 5 wt. % of one or more graft bases having glass transition temperatures of <10° C. selected from the group consisting of silicone rubbers, acrylate rubbers and EP(D)M rubbers.

6. Polymer blends according to claim 5, wherein vinyl monomer B.1 is selected from:
B.1.1 50 to 99 parts by weight of vinyl aromatics and/or ring-substituted vinyl aromatics and/or (C₁-C₈)-alkyl methacrylates and
B.1.2 1 to 50 parts by weight of vinyl cyanides, (C₁-C₈)-alkyl (meth)acrylates and/or derivatives of unsaturated carboxylic acids.

7. Polymer blends according to claim 6, wherein monomers B)
B.1 are selected from at least one of the monomers styrene, α-methyl styrene and methyl methacrylate and
B.1.2 are selected from at least one of the monomers acrylonitrile, maleic anhydride and methyl methacrylate.

8. Polymer blends according to claims 1 to 4, wherein component D is vinyl (co)polymers of at least one monomer selected from the group consisting of the vinyl aromatics, vinyl cyanides, (C₁-C₈)-alkyl (meth)acrylates, unsaturated carboxylic acids and derivatives of unsaturated carboxylic acids.

9. Polymer blends according to claims 1 to 4, characterized in that component C comprises vinyl-aromatic monomers (C.1), at least one monomer selected from the group consisting of (C₂-C₂)-alkyl (meth)acrylates, methacrylonitriles and acrylonitriles (C.2) and dicarboxylic anhydrides containing α-, β-unsaturated components.

10. Polymer blends according to one of the preceding claims, containing at least one additive selected from the group consisting of the lubricants, mould release agents, nucleating agents, antistatics, stabilizers, fillers and reinforcing substances, anti-dripping agents, finely divided inorganic compounds, dyes and pigments.

11. Polymer blends according to one of the preceding claims containing a flame retardant.

12. Use of the polymer blends according to claims 1 to 11 for producing mouldings.

13. Mouldings, characterized in that they are produced using polymer blends according to one of claims 1 to 11.

14. Housing parts, cover plates and parts for the motor vehicle sector, obtainable from polymer blends according to claims 1 to 11.
